(19) United States
(12) Patent Application Publication
(10) Pub. No.: US 2010/0203993 A1
(43) Pub. Date: Aug. 12, 2010

(54) V-RIBBED BELT

(75) Inventors: Hirokazu Matsukawa, Hyogo (JP); Hiroyuki Shiriike, Hyogo (JP)

Correspondence Address: BERLINER & ASSOCIATES, 555 WEST FIFTH STREET, 31ST FLOOR, LOS ANGELES, CA, 90013, US

(73) Assignee: BANDO CHEMICAL INDUSTRIES, LTD., Kobe-shi, Hyogo (JP)

(21) Appl. No.: 12/666,740

(22) PCT Filed: Feb. 15, 2008
(86) PCT No.: PCT/JP2008/052483

§ 371 Date: Dec. 24, 2009

(30) Foreign Application Priority Data
Jul. 26, 2007 (JP) 2007-194982

(51) Int. Cl. F16G 5/20; F16G 5/00

(52) U.S. Cl. 474/251; 474/265; 474/252; 474/249

(57) ABSTRACT

Provided is a V-ribbed belt that can suppress generation of slippage when it is splashed with water, and generation of noise. A V-ribbed belt has a rib-forming surface with plural rows of ribs formed therein and extending in a belt longitudinal direction to allow the rib-forming surface to be brought into contact with pulleys when in use, wherein the V-ribbed belt has reentrant portions on the rib-forming surface to form a non-contact area that is held out of contact with the pulleys when the V-ribbed belt is driven, so that water is allowed to flow into the non-contact area when the V-ribbed belt is splashed with water.

### FIELD OF THE INVENTION

The present invention relates to a V-ribbed belt that has a rib-forming surface, on which plural rows of ribs extend in a belt longitudinal direction.

### RELATED ART

A V-ribbed belt is generally wound between plural pulleys when in use.

The V-ribbed belt generally has a rib-forming surface, on which plural rows of ribs extend in a belt longitudinal direction, and realizes frictional transmission of power with the pulleys held contact with the rib-forming surface during belt driving.

In the frictional transmission of power using this V-ribbed belt, for example, it is known that, when the V-ribbed belt or pulleys were splashed with water, slippage occurs in a contact interface between the rib-forming surface and the pulleys, and hence abnormal noises (noises) are produced due to the generation of the slippage.

In order to deal with slippage when the belt is splashed with water, study is made on, for example, a method, which includes forming a compression rubber layer constituting the rib-forming surface with a rubber composition containing fibers, and having these fibers fibrillated to protrude from the rib surface (cf. Patent Document 1).

However, even the above method cannot satisfactorily suppress occurrence of slippage when splashed with water, and thus the conventional V-ribbed belt cannot satisfactorily suppress occurrence of abnormal noises.

Patent Document 1: Japanese Patent Application Laid-open No. Hei-07-151191

### DISCLOSURE OF THE INVENTION

### Problems to be Solved by the Invention

In consideration of the above problem, it is an object of the present invention to provide a V-ribbed belt that can suppress occurrence of slippage and hence abnormal noises when splashed with water.

### Means for Solving Problems

In order to solve the above problem, according to the present invention, there is provided a V-ribbed belt that has a rib-forming surface with plural rows of ribs formed therein and extending in a belt longitudinal direction to allow the rib-forming surface to be brought into contact with pulleys when in use, wherein the V-ribbed belt has reentrant portions on the rib-forming surface to form a non-contact area that is held out of contact with the pulleys when the V-ribbed belt is driven, so that water is allowed to flow into the non-contact area when the V-ribbed belt is splashed with water.

The reentrant portions are preferably plural rows of grooves formed in side walls of the ribs.

The reentrant portions are preferably holes formed in bottom walls of the ribs.

The plural rows of the grooves preferably include a groove extending in a transverse direction of the belt so as to allow inflow water to be discharged through a side portion of the belt, and the plural rows of the grooves are preferably disposed to cross each other.

The holes are preferably through-holes passing through the thickness of the belt.

### Advantages of the Invention

According to the present invention, the V-ribbed belt has reentrant portions on the rib-forming surface to form a non-contact area that is held out of contact with the pulleys when the V-ribbed belt is driven, so that water is allowed to flow into the non-contact area when the V-ribbed belt is splashed with water. Accordingly, it is possible to suppress water from intervening in a contact interface between the rib-forming surface and the pulleys, and suppress friction force between the rib-forming surface and the pulleys from changing when splashed with water.

Thus, it is possible to suppress occurrence of slippage in the V-ribbed belt when splashed with water, as well as suppressing occurrence of abnormal noises due to slippage.

### BRIEF DESCRIPTION OF THE DRAWINGS

FIG. 1 is a perspective view illustrating a V-ribbed belt of one embodiment.

FIG. 2 is a perspective view illustrating a V-ribbed belt of another embodiment.

FIG. 3 is a perspective view illustrating a V-ribbed belt of another embodiment.

FIG. 4 is a perspective view illustrating a V-ribbed belt of another embodiment.

FIG. 5 is a perspective view illustrating a V-ribbed belt of another embodiment.

FIG. 6 is a perspective view illustrating a V-ribbed belt of another embodiment.

FIG. 7 is a perspective view illustrating a V-ribbed belt of another embodiment.

FIG. 8 is a perspective view illustrating a V-ribbed belt of another embodiment.

FIG. 9 is a perspective view illustrating a V-ribbed belt of another embodiment.

FIG. 10 is a photograph of an external appearance illustrating the conditions of grooves of a V-ribbed belt of Example 1.

FIG. 11 is a photograph of an external appearance illustrating the conditions of grooves of a V-ribbed belt of Example 2.

FIG. 12 is a photograph of an external appearance illustrating the conditions of grooves of a V-ribbed belt of Example 3.

FIG. 13 is a schematic explanatory view illustrating a method of measuring frictional coefficient.

### DESCRIPTION OF THE REFERENCE NUMERALS

1: V-ribbed belt, 2: rib-forming surface, 3: back surface, 10: compression rubber layer, 11: rib, 11a: rib apex portion, 11b: rib side wall, 11bx: clearance, 11by: protrusion, 11c: rib bottom wall, 12a-12f: grooves, 12g: through-hole, 20: adhesive rubber layer, 30: back side layer, 40: core wire

### DETAILED DESCRIPTION OF THE PREFERRED EMBODIMENT

Now, the description will be made for a preferable embodiment of the present invention (with reference to the drawings attached hereto).

First, the description will be made for a schematic structure of a V-ribbed belt of this embodiment.

The V-ribbed belt of this embodiment has an entire body formed into an endless shape with a band-like belt.

The V-ribbed belt has a rib-forming surface on its inner circumferential side with plural rows of ribs extending in a belt longitudinal direction to allow the inner circumferential surface to be brought into contact with pulleys when in use.

The V-ribbed belt has reentrant portions on the rib-forming surface to form a non-contact area that is held out of contact with the pulleys when the V-ribbed belt is driven, so that water is allowed to flow into the non-contact area when the V-ribbed belt is splashed with water.

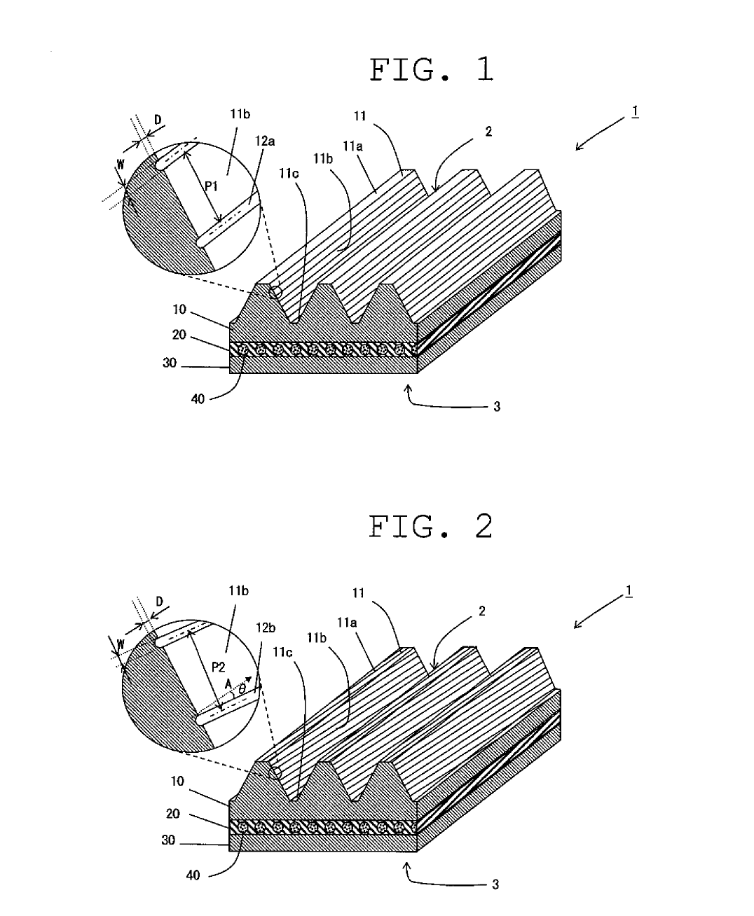

FIG. 1 is a view illustrating the V-ribbed belt of this embodiment and a perspective view showing a portion of the V-ribbed belt with the rib-forming surface directed upward.

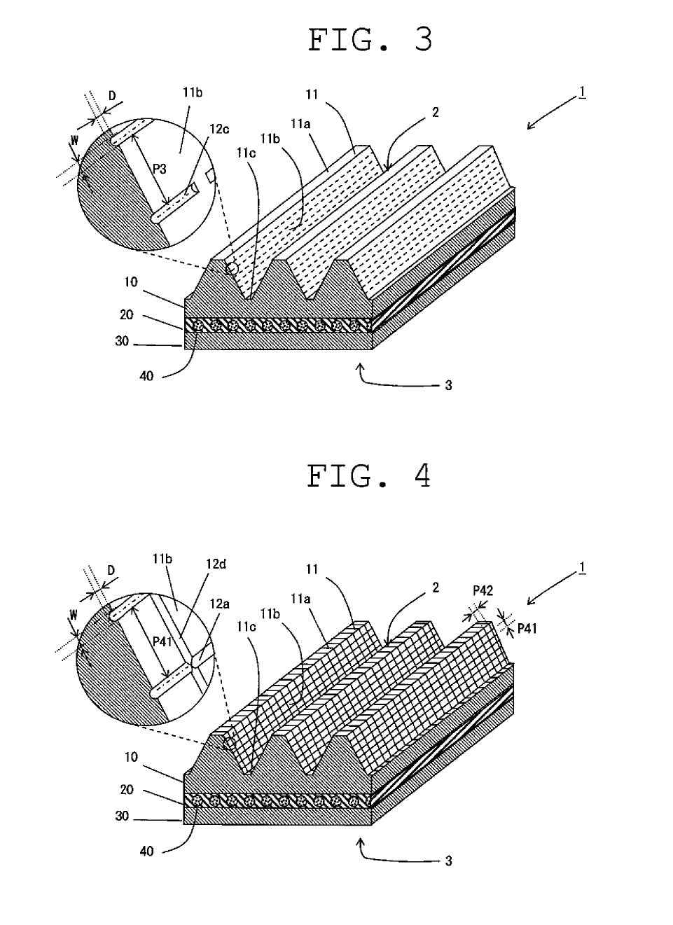

V-ribbed belts of other embodiments are shown in FIGS. 2-9.

An enlarged view with an enlarged circular region shown in Figure is also shown at a left upper portion of each perspective view.

In FIGS. 1-9, the identical structures or elements are represented by allocating the same reference codes thereto.

In Figures, a reference numeral 1 represents a V-ribbed belt, and a reference numeral 2 represents a rib-forming surface (inner circumferential surface). A reference numeral 3 represents a back surface (outer circumference surface) which is opposite to the rib-forming surface.

A reference numeral 10 represents a compression rubber layer that is a first rubber layer forming a portion of an innermost side of a V-ribbed belt 1, and this compression rubber layer 10 is continuously formed in a belt circumferential direction of the V-ribbed belt 1.

A reference numeral 11 represents ribs formed on the compression rubber layer 10.

That is, the rib-forming surface 2 is formed by a surface on the inner circumferential side of the compression rubber layer 10.

This ribs 11 each are formed to become gradually narrower towards an upper side (inner circumferential side) and thus have a substantially isosceles trapezoidal shape in cross section.

Reference numerals 11a, 11b, 11c represent respective portions of the ribs 11, in which 11a represents a rib apex portion that is a portion corresponding to an upper base of the isosceles trapezoid, and 11b represents a rib side wall that is a portion corresponding to an oblique line of the above isosceles trapezoid.

A reference numeral 11c represents a rib bottom wall that is a bottom portion between valleys formed between adjacent ribs.

A reference numeral 20 represents an adhesive rubber layer that is a second rubber layer forming the V-ribbed belt, and a reference numeral 30 represents a back side layer that is a third rubber layer forming a portion of an outermost circumferential side of the V-ribbed belt 1.

That is, as illustrated in Figures, the V-ribbed belt 1 of this embodiment has a multi-layer structure of three layers including the back side layer 30, the adhesive rubber layer 20 and the compression rubber layer 10 arranged in this order from the belt outer circumferential side to the belt inner circumferential side (from the lower layer side to the upper layer side).

A reference numeral 40 represents core wire, and the core wire 40 is provided to the V-ribbed belt by being embedded in the adhesive rubber layer 20.

The core wire 40 extends in a belt circumferential direction, and a single core wire is wound plural times into spiral shape within the V-ribbed belt 1 and embedded therein.

As illustrated in Figures, in a cross section taken in the direction crossing the belt in a width direction, the core wire 40 is embedded to have cross sections aligned in the belt width direction with intervals.

Now, the detailed description will be made in more detail for reentrant portions formed in the rib-forming surface 2, with reference to FIGS. 1 to 9.

The V-ribbed belt exemplified in FIG. 1 has plural rows of grooves 12a formed in the rib side wall 11b as the reentrant portions.

The plural rows of grooves 12a in FIG. 1 continuously extend in the extending direction of the ribs 11, and are disposed in parallel to each other with a constant distance therebetween.

Specifically, the plural rows of grooves 12a in FIG. 1 are formed on each rib side wall 11b to be parallel with each other without crossing each other, so that, when any substance moves on the inner circumference (rib-forming surface 2) of the V-ribbed belt 1 through a single groove, it repeatedly goes around through the same groove.

No limitation is intended to the grooves 12a of FIG. 1, as long as the grooves have such a width (“W” in Figures), a depth (“D” in Figures) and a distance (pitch) between adjacent grooves (“P1” in Figures) as to allow at least a portion of the inner surface side of each groove 12a to act as a non-contact area held out of the pulleys when the V-ribbed belt is driven.

For example, the grooves 12a exemplified in FIG. 1 may generally have a width of 50-150 μm, a depth of 50-300 μm and a pitch of 100 to 200 μm in a conventional V-ribbed belt having a size of about several millimeters in rib width and rib height.

Among them, from the view point of drainage property and wear resistance, the width of the grooves 12a is preferably in a range of 70-120 μm.

The depth of the grooves 12a is preferably in a range of 100-250 μm.

The pitch of the grooves 12a is preferably in a range of 120-180 μm.

Of the surface area of the rib-forming surface 2, the area ratio occupied by the grooves 12a is preferably in a range of 10-70%.

In FIG. 1, a groove having a semi-circular cross section is exemplified, but no limitation is intended to the groove shape. For example, various shapes such as a rectangular shape and a wedge shape in section may be employed.

This groove may be formed by, for example, once forming a rib 11 and then irradiating the rib side wall 11b with laser by a laser processing machine or the like, thereby carrying out engraving at a constant depth.

Now, the description will be made for a second embodiment of the reentrant portions.

The V-ribbed belt 1 exemplified in FIG. 2 is formed in the same manner as the V-ribbed belt of FIG. 1, except that grooves 12b each extend in a direction defining a predetermined angle (“θ” in Figures) relative to the extending direction of the ribs 11 (“arrow A” in Figures).

The grooves 12a of FIG. 1 is formed so as to cause any substance to repeatedly go around through the same groove when it moves through a single groove on the inner circumferential surface (rib-forming surface) of the V-ribbed belt, and on the other hand, the V-ribbed belt 1 of FIG. 2, which has the grooves 12b extending at an angle (θ) relative to the extension direction A of the ribs 11, causes not to go around through the same groove, but to change its position relative to the width direction of the V-ribbed belt 1, when it moves through a single groove 12b on the inner circumferential surface (rib-forming surface).

In addition, the grooves 12b of FIG. 2 are formed not only on the rib side wall 11b, but also on the rib apex portion 11a and the rib bottom wall 11c, continued from the grooves 12b of the rib side wall 11b, so as to be continuously formed in a transverse direction of the belt.

Accordingly, when any substance moves on the inner circumferential surface (rib-forming surface 2) of the V-ribbed belt 1, passing through the groove formed at one end side in the belt width direction, it moves across the belt from the one end side to the opposite end side by making a partial or full circuit, or more circuits.

Thus, with the grooves extending at an inclined angle in a direction crossing the belt, water can be flown into the grooves 12b when splashed with water when the V-ribbed belt is driven.

Furthermore, water flown in by centrifugal force effected by the belt driving can be let flow along the grooves 12b.

Accordingly, water which has been drawn into the grooves 12b can be finally discharged through a side portion of the belt, and thus slippage of the V-ribbed belt 1 can be further suppressed.

Now, the description will be made for a third embodiment of the reentrant portions with reference to FIG. 3.

The V-ribbed belt 1 exemplified in FIG. 3 has the grooves 12c formed on each rib side wall 11b, which do not continue in the extending direction of the ribs 11 but are formed in broken line.

The V-ribbed belt 1 exemplified in FIG. 3 is formed in the same manner as the V-ribbed belt exemplified in FIG. 1, except that the grooves 12c do not continue in the extending direction.

That is, in the V-ribbed belt 1 exemplified in FIG. 3, the grooves 12c extend in the extending direction of the ribs 11 while broken apart, and are disposed parallel to each other with a constant interval.

The width W, the depth D and the pitch P3 of the grooves 12c exemplified in FIG. 3 may be set to be values respectively equivalent to the width, the depth and the pitch set forth in explanation of the V-ribbed belt exemplified in FIG. 1.

The cross sectional shape of the grooves is not necessarily limited to a semi-circular shape exemplified in Figure in the same manner as the V-ribbed belt exemplified in FIG. 1.

Now, the description will be made for a fourth embodiment of the reentrant portions with reference to FIG. 4.

In the V-ribbed belts exemplified in FIGS. 1-3, all the grooves extend in one direction, but the V-ribbed belt 1 exemplified in FIG. 4 has grooves 12d extending in a direction orthogonal to the extending direction of the ribs 11 (a transverse direction of the V-ribbed belt) (hereinafter referred also to as “lateral grooves 12d”), in addition to the grooves 12a (hereinafter referred also to as “longitudinal grooves 12a”) continuously extending in the extending direction of the ribs 11 in the same manner as the V-ribbed belt exemplified in FIG. 1.

That is, the V-ribbed belt exemplified in FIG. 4 has the longitudinal grooves 12a and the lateral grooves 12d extending in different directions so as to cross each other.

In addition, the lateral grooves 12d are formed on the rib apex portion 11a and the rib bottom wall 11c, as well, which are continuously formed with grooves formed on the rib side wall 11b, and are continuously formed in the transverse direction of the belt.

Accordingly, water drawn into the longitudinal grooves 12a, etc., due to water splashing can be discharged from a side portion of the belt through the lateral grooves 12d.

Specifically, the V-ribbed belt exemplified in FIG. 4 produces the same effect as that of the V-ribbed belt exemplified in FIG. 2, when splashed with water.

Accordingly, it is possible to further suppress occurrence of slippage due to water splashing by the use of the V-ribbed belt 1 exemplified in FIG. 4.

The lateral grooves 12d of the V-ribbed belt exemplified in FIG. 4 may generally have a width and a depth equivalent to those of the longitudinal grooves 12a, and a pitch P42 of these lateral grooves 12d may be generally equivalent to the pitch P41 of the longitudinal grooves 12a.

The width W, the depth D and the pitch P41 (P42) of the grooves 12a (12d) exemplified in FIG. 4 may be generally equivalent to the width, the depth and the pitch set forth in an explanation of the V-ribbed belt exemplified in FIG. 1.

The V-ribbed belt of FIG. 4 is also the same as the V-ribbed belt exemplified in FIG. 1 in terms of the fact that the cross sectional shape of these grooves are not limited to a semi-circular shape.

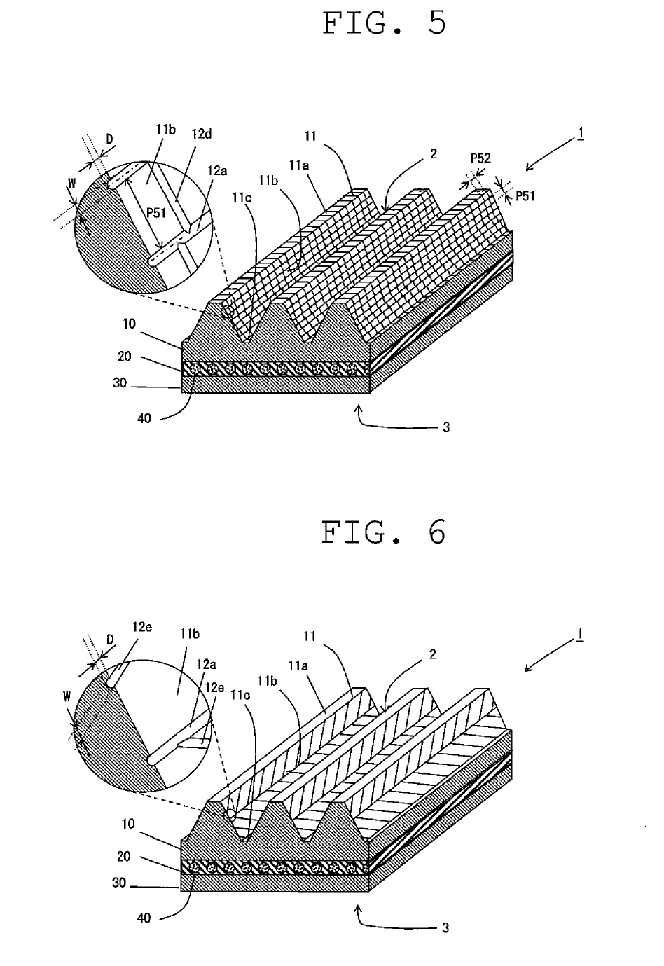

Now, the description will be made for a fifth embodiment of the reentrant portions with reference to FIG. 5.

The longitudinal grooves 12a and the lateral grooves 12d are formed on the rib-forming surfaces in the same manner as that of the V-ribbed belt exemplified in FIG. 4, except that the lateral grooves 12d of the V-ribbed belt of FIG. 5 do not extend straight in the transverse direction of the belt.

Specifically, the lateral grooves 12d are formed such that the lateral groove 12d crossing between adjacent longitudinal grooves 12a is formed at a position displaced from the position at which the lateral groove extending to the next adjacent longitudinal grooves 12a is formed.

Therefore, when any substance moves in the transverse direction of the belt through the lateral grooves 12d, the substance which has crossed between adjacent longitudinal grooves 12a through a single lateral groove 12d cannot cross the next adjacent longitudinal groove 12a unless it moves along a longitudinal groove 12a.

Thus, square regions surrounded by the lateral grooves 12d and the longitudinal grooves 12a, which respectively have the centers aligned straight in the vertical and lateral directions of the rib-forming surface 2 in the V-ribbed belt 1 exemplified in FIG. 5, are disposed in zig-zag fashion in the lateral direction in the V-ribbed belt 1 exemplified in FIG. 5.

The V-ribbed belt 1 exemplified in FIG. 5 is the same as the V-ribbed belt exemplified in FIG. 4 in terms of that the lateral grooves 12d generally have the same width and depth as those of the longitudinal grooves 12a, and the pitch P52 of the lateral grooves 12d is set to be equivalent to the pitch P51 of the longitudinal grooves 12a.

The V-ribbed belt 1 exemplified in FIG. 5 is also the same as the V-ribbed belt exemplified in FIG. 4 in terms of that the width W, the depth D and the pitch P51 (P52) of the grooves 12a (12d) are generally equivalent to the width, the depth and the pitch set forth in an explanation of the V-ribbed belt exemplified in FIG. 1, and the cross sectional shape of the grooves is not limited to a semi-circular shape.

In the V-ribbed belt 1 exemplified in FIG. 5, square regions surrounded by the grooves act as regions contacting pulleys (hereinafter referred also to “contacting regions”) when the V-ribbed belt is driven.

Since the contacting regions are provided with the centers thereof disposed in zig-zag fashion in the lateral direction (belt width direction), they grooves are more finely dispersed on the rib-forming surface.

Therefore, the V-ribbed belt 1 exemplified in FIG. 5 can allow water adhered on the surfaces of the contacting regions due to water splashing to be easily drawn into the grooves, which can provide an advantageous effect of further suppressing occurrence of slippage.

Now, the description will be made for a sixth embodiment of the reentrant portions with reference to FIG. 6.

In the V-ribbed belt 1 of FIG. 6, only a single groove 12a, which continuously extends in the extending direction of the ribs 11, is formed along a substantially center of each of the side walls 11b, and this center positioned groove 12a (hereinafter referred also to “center groove 12a”) has grooves 12e branching therefrom and extending in a such a direction as to expand in branching pattern with certain intervals on each of the rib side wall 11b.

Therefore, for example, by driving the V-ribbed belt 1 in a direction, in which the contacting portion with pulleys move from a branch starting position, at which each branch groove 12e starts branching from the center groove 12a, to a side on which the branch grooves 12e expand, it is possible to let water flow into the center grooves 12a at the time of water splashing and thus make the V-ribbed belt 1 exert the function of allowing water to flow into the branch grooves 12e and the like, and the inflow water to be further discharged through the end portions of the branch grooves 12e.

That is, the V-ribbed belt 1 exemplified in FIG. 6 produces an advantageous effect of further suppressing occurrence of slippage in the same manner as the V-ribbed belt exemplified in FIG. 6, although it is different from the V-ribbed belts exemplified above in function.

The V-ribbed belt 1 of FIG. 6 is the same as the V-ribbed belts exemplified above in terms of that the width and the depth of the center grooves 12a and the branch grooves 12d are generally equivalent to those set forth in an explanation of the V-ribbed belt exemplified in FIG. 1, and the cross sectional shape of the grooves is not limited to a semi-circular shape.

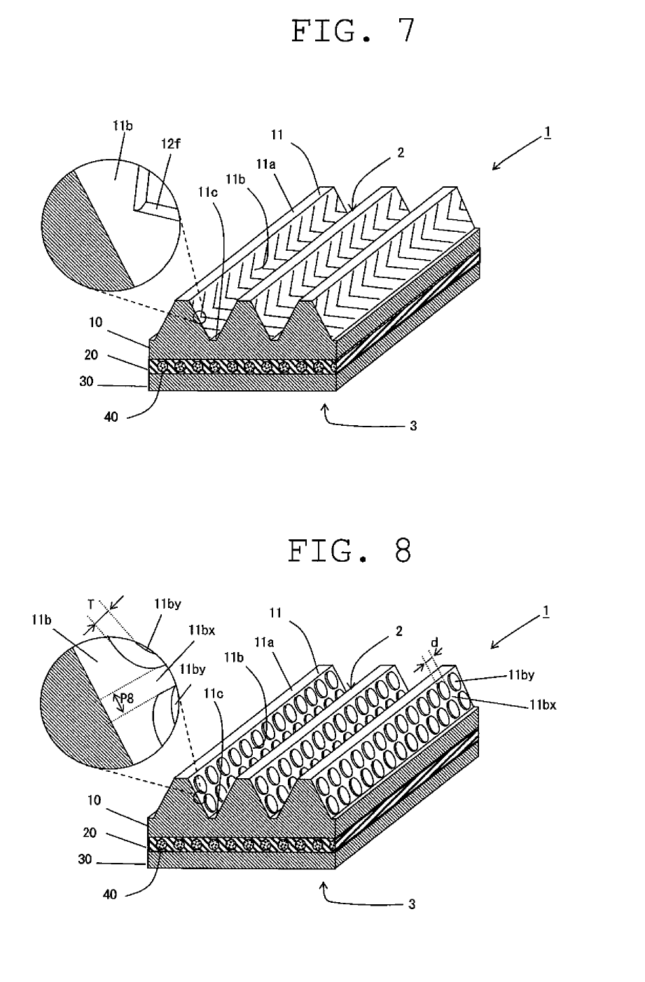

Now, the description will be made for a seventh embodiment of the reentrant portions with reference to FIG. 7.

In the V-ribbed belt of FIG. 7, grooves 12f are formed such that grooves each being bent in V-shape are formed on each rib side wall 11b with the bent portions facing in the rib extending direction, thus having a herringbone-shaped overall appearance.

In the same manner as the V-ribbed belt exemplified in FIG. 6, the V-ribbed belt of FIG. 7 can exert the function of allowing water to be discharged through the end portions of the grooves 12f when water splashing, by driving the V-ribbed belt 1 so as to allow the contacting portion between pulleys and the rib-forming surface 2 to move to a side, on which the herringbone-shaped grooves 12f expand in V-shape.

That is, the V-ribbed belt 1 exemplified in FIG. 7 produces an advantageous effect of further suppressing occurrence of slippage in the same manner as the V-ribbed belt exemplified in FIG. 6.

Now, the description will be made for an eighth embodiment of the reentrant portions with reference to FIG. 8.

In the V-ribbed belt 1 of FIG. 8, circular plate-shaped projections 11by are formed in plural on each rib side wall 11b.

These plural projections 11by are arranged on each rib side wall 11b with slight intervals from each other, and regions 11bx (hereinafter referred also to “clearance portions 11bx”) between the projections 11by are formed as non-contact areas, which are held out of contact with the pulleys.

That is, the V-ribbed belt 1 of FIG. 8 is provided with the clearance portions 11bx as reentrant portions that are formed to be directed inwardly from the surfaces of the projections.

The height of the circular plate-shaped projections 11by (thickness of circular plate: “T” in Figure), the width of the projections 11by (diameter of circular plate: “d” in Figure), and the distance between adjacent projections (distance between the peripheral ends of the circular plates: “P8” in Figure) are not necessarily limited to specific ones, as long as at least a part of these clearance portions 11bx can be functioned as non-contact areas when the V-ribbed belt is driven.

For example, with respect to the projections 11by exemplified in FIG. 8, for a conventional V-ribbed belt with ribs having about several millimeters in width and height, there can be applied a height (T) of 100-500 μm, a width (d) of 100-700 μm, and a distance (P8) between adjacent projections of 100-200μm.

Among them, from the view point of drainage property and wear resistance against friction, the height T of the projections 11by is preferably in a range of 200-400 μm.

The width d of the projections 11by is preferably in a range of 300-600 μm.

The distance P8 between adjacent projections is preferably in a range of 100-150 μm.

Furthermore, of the surface area of the rib-forming surface 2, the area proportion occupied by the projections 11by is preferably in a range of 30-70%.

Although the description was made by taking, for example, a circular plate-shaped projection, it is possible to employ projections having various shapes, such as a rectangular plate shape, a triangular plate shape and an undefined shape.

Now, the description will be made for a ninth embodiment of the reentrant portions with reference to FIG. 9.

The V-ribbed belt 1 of FIG. 9 has holes opening through the rib bottom wall 11c. These holes are through-holes 12g passing through from the rib-forming surface 2 to the back surface 3 in a belt thickness direction.

That is, in the V-ribbed belts exemplified as above, grooves extending across a certain region on each rib side wall 11b are provided as reentrant portions. In the V-ribbed belt 1 of FIG. 9, the through-holes 12g opening through the rib bottom wall 11c are provided as reentrant portions.

Generally, when water splashing takes place when the V-ribbed belt is driven, water tends to converge into valley portions between the ribs along the surfaces of the ribs 11.

Accordingly, the V-ribbed belt 1 exemplified in FIG. 9 with the reentrant portions formed for inflow of water into the rib bottom wall 11c enables water to be more efficiently drawn into the reentrant portions, and can suppress intervention of water in a contact interface between the rib-forming surface 2 and the pulleys.

Furthermore, the V-ribbed belt 1 exemplified in FIG. 9, which has the through-holes 12g as the reentrant portions, enables inflow water to be discharged towards the back surface 3 such that intervention of water in a contact interface between the rib-forming surface 2 and the pulleys can be further suppressed.

Although no limitation is intended to the shape, the size, and the number of the through-holes 12g, forming through-holes having a large diameter or forming a large number of through holes in a single V-ribbed belt may deteriorate the strength of the V-ribbed belt.

On the other hand, forming through-holes having a small diameter or reducing the number of through-holes may cause unsatisfactory discharge of water from the back surface 3.

Thus, the through-holes 12g have preferably a diameter of 0.1-2.0 mm from the point of view that it is possible to exhibit excellent discharge performance while suppress deterioration of the strength of a V-ribbed belt.

The number of through-holes is preferably selected such that the interval between the through-holes (pitch P9) is in a range of several millimeters to several tens centimeters when they are formed along the rib bottom wall 11c.

The through-holes p12g preferably have a circular cross section so as to enable suppressing of occurrence of local stress at the through-holes 12g when the V-ribbed belt is driven.

The through-holes 12g may be formed by using a laser processing machine or the like in the same manner as grooves.

In the present invention, reentrant portions are not necessarily limited to grooves and holes exemplified in FIGS. 1-9, and for example, curvedly formed holes or grooves not orientedly arranged may be employed as reentrant portions in a V-ribbed belt.

Through-holes formed to diagonally pass through a V-ribbed belt, or through-holes having bent portions in a middle thereof may be employed as reentrant portions.

Furthermore, the combination of any of the above grooves and holes may be employed in a single V-ribbed belt.

The compression rubber layer 10, the adhesive rubber layer 20 and the back side layer 30, of the V-ribbed belt of this embodiment may be formed of materials used for forming a conventional V-ribbed belt.

For the core wire 40, core wires used for a conventional V-ribbed belt may be used.

In this embodiment, the description was made for the V-ribbed belt by taking, for example, a case where a rubber layer extending in the belt circumferential direction. However, the V-ribbed belt of the present invention is not necessarily limited to a V-ribbed belt made of a rubber, and a V-ribbed belt made of a resin falls within an intended scope of the present invention.

Furthermore, various improvements applied to a conventional V-ribbed belt may be employed in the V-ribbed belt of the present invention to such an extent as not to deteriorate advantageous effects of the present invention.

### Examples

Now, the description will be made for the present invention with reference to the following examples without intention to limit the invention thereto.

### Examples 1-3, Comparative Example 1

In each of Examples and Comparative Example, a V-ribbed belt having a belt width of 10 mm, 3 ribs and a rib height of 2.5 mm was fabricated by using the same rubber composition.

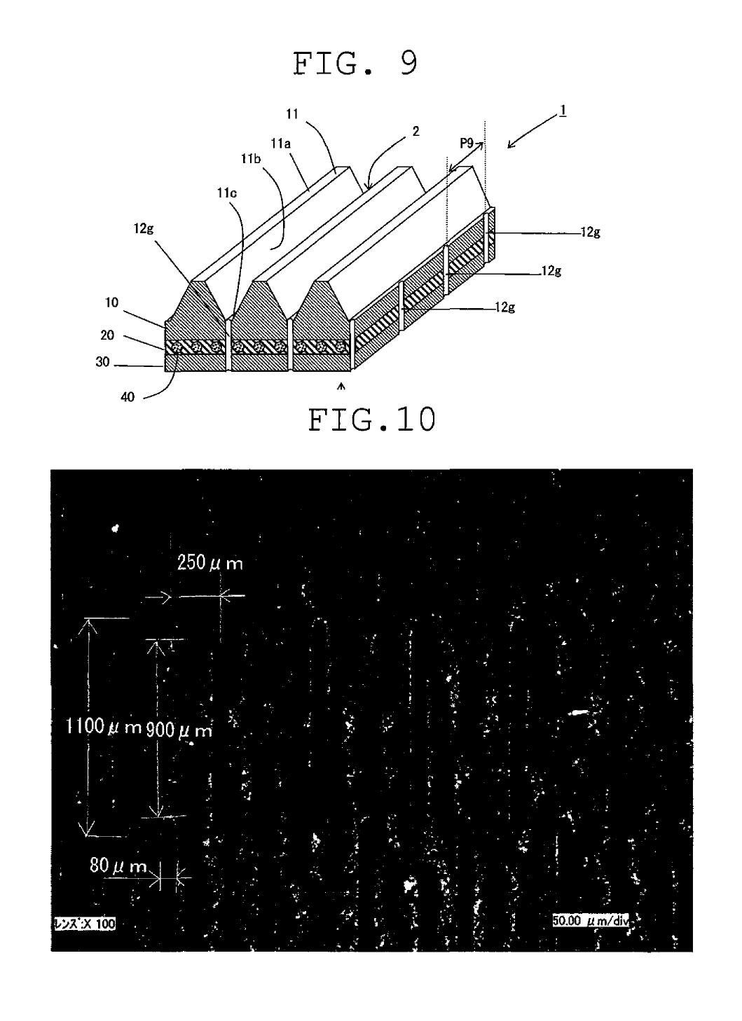

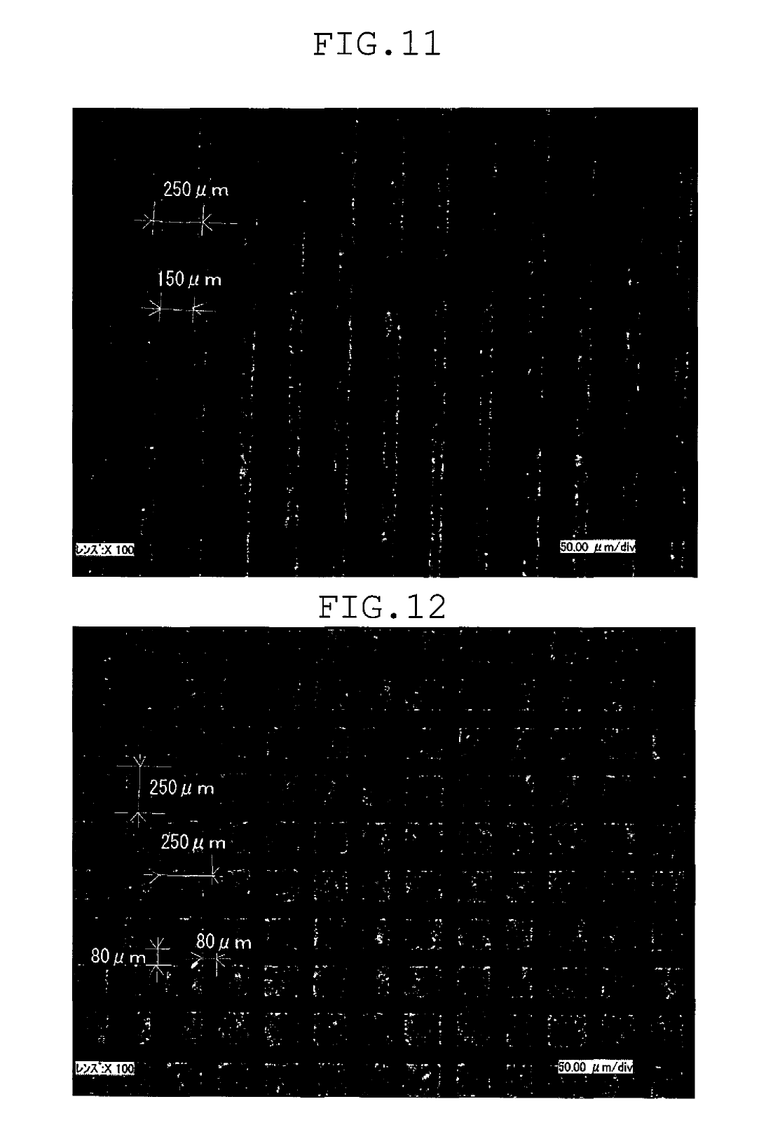

Grooves were formed in the patterns shown in FIG. 10 (Example 1), FIG. 11 (Example 2) and FIG. 12 (Example 3) by using a laser processing machine on the entire rib-forming surface of each V-ribbed belt.

FIGS. 10-13 are photomicrographs as a result of surface observation using a microscope.

A V-ribbed belt of Example 1 has grooves having a width of about 80 μm, formed in broken line (a section through which each groove is formed: about 1100 μm, a section through which no groove is formed: about 900 μm), and arranged at a pitch of 250 μm, and a V-ribbed belt of Example 2 has grooves having a width of about 150 μm, formed in straight line and arranged at a pitch of 250 μm.

Furthermore, a V-ribbed belt of Example 3 has grooves having a width of about 80 μm, formed in straight line and arranged at a pitch of 250 μm in both the vertical and lateral directions, creating a lattice pattern.

As Comparative Example 1, a V-ribbed belt having no grooves and the like is used to carry out evaluations mentioned below.

(Evaluation)

(Measuring Method of Friction Coefficient)

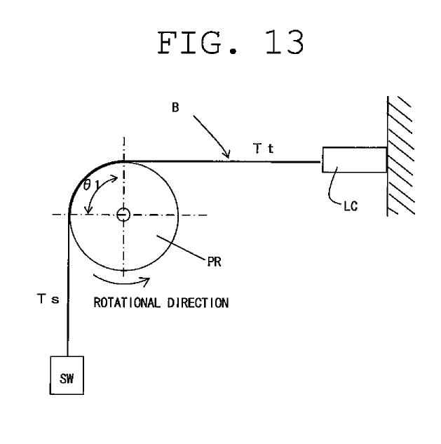

Measuring of friction coefficient was carried out by using a device as shown in FIG. 13.

Specifically, measuring specimens (“B” in Figure) each formed by cutting each of the V-ribbed belts into a predetermined length are each connected at its one end to a load cell (“LC” in Figure) mounted on a vertical wall and fixedly mounted to a wall surface to enable measuring of stress in a horizontal direction, while a load of 1.75 kg (“SW” in Figure) is mounted to the opposite end of each measuring specimen, and a substantially intermediate portion of each measuring specimen is supported on a pulley (“PR” in Figure) having a diameter of 60 mm disposed on a side forward to a stress measuring direction of the load cell.

At this moment, a substantially intermediate portion of each measuring specimen is supported on a pulley to have an angle of a contacting section of the measuring specimen contacting the pulley (“θ1” in Figure) being 90 degrees.

Specifically, each measuring specimen is supported in a horizontal direction through a section between an upper end of the pulley and the load cell fixing position, and the pulley is set at such a position to allow each measuring specimen to suspend vertically downward through a section from a lateral end of the pulley to the load.

With this positioning, the pulley is rotated at a speed of 20 rpm to have an upper portion thereof moving away from the load cell (in a direction represented by an arrow in Figure), and the stress (Tt) applied to the load cell was measured during rotation.

Then, the frictional coefficient (μ′) was measured by using the following equation on the basis of the stress (Tt) applied to the load cell and the stress (Ts=1.75 kgf) applied in a vertical section of the specimen.

Frictional coefficient (μ′)=ln(Tt/Ts)/0.5π

(Change in Frictional Coefficient at the Time of Water Splashing)

By the measuring method of the frictional coefficient as disclosed above, the frictional coefficient (μₒ′) at the time when the belt is dried, and the frictional coefficient (μ′) at the time when water was poured on a pulley at a pouring rate of 2000 cm³/min were measured, and the frictional coefficient variation amount (Δμ′) was measured by using the following equation.

Frictional coefficient variation amount (Δμ′)=μ₀′−μ₁′

The measured results are shown in Table 1.

The V-ribbed belts of Examples 1-3 and Comparative Example 1 are respectively wound around pulleys that are arranged in the same conditions, and water is poured thereon. The magnitude of noise (noise level) generated after the pouring of water (when in dry condition) was measured by using a noise level meter.

The results are shown in Table 1.

TABLE 1

| | | | | Comparative |
|---|---|---|---|---|
| | Example 1 | Example 2 | Example 3 | Example 1 |
| Frictional coef- | −0.22 | −0.15 | −0.02 | −0.35 |
| ficient variation | | | | |
| amount (Δμ′) | | | | |
| Noise level (dB) | 88 | 76 | 70 | 90 |

It is apparent from Table 1 that it is possible to suppress variation of the frictional coefficient at the time of water splashing, and suppress generation of slippage and hence abnormal noises due to slippage, according to the present invention.

1. A V-ribbed belt that has a rib-forming surface with plural rows of ribs formed therein and extending in a belt longitudinal direction to allow the rib-forming surface to be brought into contact with pulleys when in use, wherein the V-ribbed belt has reentrant portions on the rib-forming surface to form a non-contact area that is held out of contact with the pulleys when the V-ribbed belt is driven, so that water is allowed to flow into the non-contact area when the V-ribbed belt is splashed with water.

2. A V-ribbed belt according to claim 1, wherein the reentrant portions comprise plural rows of grooves formed in side walls of the ribs.

3. A V-ribbed belt according to claim 2, wherein the plural rows of the grooves include a groove extending in a transverse direction of the belt so as to allow inflow water to be discharged through a side portion of the belt

4. A V-ribbed belt according to claim 2, wherein the plural rows of grooves are disposed to cross each other.

5. A V-ribbed belt according to claim 1, wherein the reentrant portions are holes opening through a rib bottom wall.

6. A V-ribbed belt according to claim 5, wherein the holes are through-holes passing through the thickness of the belt.

7. A V-ribbed belt according to claim 3, wherein the plural rows of grooves are disposed to cross each other.
